(19) United States
(12) Patent Application Publication
(10) Pub. No.: US 2016/0326382 A1
(43) Pub. Date: Nov. 10, 2016

(54) WATER-SOLUBLE THICKENING AGENT FOR AQUEOUS SYSTEMS, FORMULATIONS CONTAINING SAME AND USES THEREOF

(71) Applicant: COATEX, Genay (FR)

(72) Inventors: Denis RUHLMANN, Genay (FR); Jean-Marc SUAU, Lucenay (FR); Yves MATTER, Quincieux (FR)

(73) Assignee: COATEX, Genay (FR)

(21) Appl. No.: 15/104,318

(22) PCT Filed: Dec. 15, 2014
(86) PCT No.: PCT/FR2014/053343

§ 371 Date: Jun. 14, 2016

(30) Foreign Application Priority Data
Dec. 16, 2013 (FR) 1362672

(51) Int. Cl. C09D 7/00; C08G 18/48; C08G 18/75; C08G 18/28

(52) U.S. Cl. CPC C09D 7/002; C08G 18/283; C08G 18/4833; C08G 18/755

(57) ABSTRACT

The present invention relates to new associative thickeners belonging to the category of HEUR (Hydrophobically modified Ethoxylated URethane), as well as intermediate aqueous compositions containing such thickeners and end formulations, for example formulations of paint, lacquer, varnish or paper coating colour.

The present invention relates to new associative thickeners belonging to the category of HEURs (Hydrophobically modified Ethoxylated URethane). These products contain an associative compound of the polyalkoxylated pentastyrylcumylphenol type. The present invention also relates to intermediary aqueous compositions containing such thickeners, as well as the end formulations, for example paint formulations.

Paints are consisted of fillers and pigments and of at least one organic polymer called binder. Besides fillers, pigments and the binder, a paint formulation also comprises a solvent (which is water in the case of paints in aqueous phase), additives for rheology, additives for stability (storage, film formation and UV) and other additives to obtain special properties. The behavior and properties of paints depend on the nature of their constituents, particularly on the binder, fillers and pigments as well as rheological additives. They generally contain one or more thickeners whose function is to control the rheology of the formulations, not just at the time of their production, but also during their transport, storage or during their implementation. Given the diversity of practical constraints in each of these steps, it is beneficial for the formulator to have access to a range of thickeners with different rheological behaviors in formulation.

Among all the thickeners for paint, there are:
natural cellulose-based thickeners also called cellulosic ethers of the HEC or HMHEC (Hydrophobically Modified HEC) type,
non-associative type acrylic thickeners, called ASE (Alkali Swellable Emulsions) and associative type ones, called HASE (Hydrophobically modified Alkali Swellable Emulsions) and
associative polyurethane thickeners of the HEUR (Hydrophobically modified Ethoxylated URethane) type.

HASE thickeners may, for example, be obtained by polymerization in the presence of an anionic surfactant, a (meth)acrylic acid monomer, an alkyl (meth)acrylate monomer and a hydrophobic monomer consisted of a long aliphatic chain.

Polyurethane or HEUR thickeners, on the other hand, result from the polymerization between a poly(alkylene glycol) type compound, a polyisocyanate and an associative monomer of the alkyl, aryl or aryalkyl type consisted of a hydrophobic terminal group.

Although HASE and HEUR thickeners belong to the category of associative thickeners, the thickening mechanism cannot be considered as totally identical. Indeed, the thickening mechanism of the aqueous formulation in the presence of a HASE is due to the presence of hydrophobic groups which may assemble in the form of micellar aggregates, but also to the formation of a gel that results from ionic bonds between the carboxylic functions carried by the skeleton of the polymer and the water molecules of the aqueous solvent (JCT Research, Vol. 2 No 6, April 2005—W. Wu and G. D. Shay—Tailoring HASE Rheology Through Polymer Design: Effects of Hydrophobe Size, Acid Content, And Molecular Weight). Unlike HASE thickeners, the HEUR thickeners are non-ionic components and their thickening mechanism is not dependent on ionic interactions within the medium. ((Polymers as Rheology Modifiers—Chap. 12: Systems approach to Rheology Control—pp. 207-221—ACS Symposium Series 462, 1991).

Thus, the rheological behaviors of HEUR and HASE thickeners may vary considerably while the hydrophobic monomers are identical.

The behaviors of the different thickeners on the market may be summarized as follows:

| | Associative | Non-associative | Typical molecular |
|---|---|---|---|
| Thickener | thickening | thickening | weight |
| HEUR | yes | negligible | <50,000 g/mol |
| ASE | no | yes | 100,000-1,000,000 g/mol |
| HASE | yes | yes | |
| HEC | no | yes | 3,000-100,000 g/mol |
| HMHEC | yes | yes | |

Coatex has engaged in a great deal of research regarding thickeners for paint. Furthermore, Coatex sells products in its Coapur® line, such as Coapur® XS products, which are non-ionic polyurethane thickeners that confer rheological profiles that vary between the Newtonian type (high viscosity when shear gradient is high and low viscosity when velocity gradient is low) and/or the pseudoplastic type (high viscosity when shear gradient is low). Such non-ionic products have the advantage of developing a thickening power that is less dependent on the pH of the formulation than HASE type thickeners.

The document WO 02/102868 (Coatex), for example, relates to thickening polyurethanes of the ethylene oxide chain polymer type, which comprise at the ends of chains hydrophobic groups comprising several aromatic rings, particularly distyrylphenyl and tristyrylphenyl. Such thickeners make it possible to obtain a high viscosity at a low shear gradient and good pigment compatibility regardless of the type of paint (matt or glossy).

The document WO 2006/048539 (Coatex) indicates that the use of HASE with a hydrophobic group of the alkyl type that may contain up to 32 carbon atoms or of the aromatic type that may contain more than 50 carbon atoms, makes it possible to obtain a good dynamic behavior (high viscosity at a high shear gradient) and a good static behavior (high viscosity at a low shear gradient). This document relates only to HASE type thickeners.

Although this document describes the advantages of a hydrophobic group containing a high number of carbon atoms, it does not describe a polyurethane thickener with such a group.

Indeed, it is known that it is technically difficult to formulate, in an aqueous phase, polyurethanes with, at the ends of chains, hydrophobic groups with a very high number of carbon atoms. Additionally, even if formulation in aqueous phase is possible, it is also difficult to thicken the end formulations by hydrophobic interactions.

In view of this, the inventors have developed a new polyurethane thickener that makes it possible to very substantially increase the viscosity at a low shear gradient and thereby to give to the formulation a good static behavior, i.e. a high viscosity at a low shear gradient, while maintaining a very good pigment compatibility. This thickener may be classified in the category of pseudoplastic type thickeners.

This new thickener may, for example, be used alone in a paint formulation where it is not necessary to have a high viscosity at a high shear gradient (for example, a matt paint or a thick or waterproof plastic coating).

It may also be used in combination with a Newtonian type thickener. Such a combination thereby makes it possible to obtain a formulation with a good static behavior due to the presence of the pseudoplastic type thickener and a good dynamic behavior due to the presence of the Newtonian thickener.

Such a thickener may be formulated in an aqueous phase and, owing to its particular structure, it allows the end formulation to be thickened without requiring special equipment or high shear energy.

### HEUR Thickener

An object of the present invention relates to a thickener belonging to the category of HEUR (Hydrophobically modified Ethoxylated URethane). This is a water-soluble associative thickening polymer for aqueous compositions.

More specifically, it is a water-soluble polyurethane resulting from the condensation of:
a) at least one compound of formula (I):

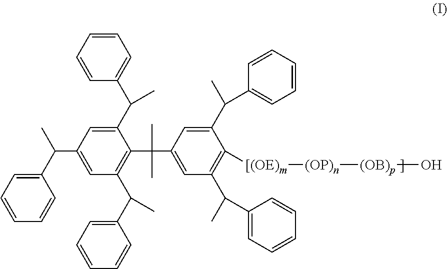

in which:
   [(EO)ₘ—(PO)ₙ—(BO)ₚ] represents a polyalkoxylated chain consisted of alkoxylated units, in blocks, alternating or random structures, chosen from among ethoxylated units EO, propoxylated units PO, and butoxylated units BO and
   m, n and p represent, independent of one another, 0 or a whole number varying between 1 and 250 inclusive, the sum of m, n and p being between 2 and 250,
b) at least one polyol, for example at least one poly(alkylene glycol) and
c) at least one polyisocyanate.

In the context of the present invention, the compound of formula (I) is called polyalkoxylated pentastyrylcumylphenol. “Pentastyrylcumylphenol” means an aromatic cumylphenol cycle on which five styrene units are grafted.

The compounds of formula (I) contain a polyalkoxylated chain, including at least 2 alkoxylated units.

The compound of formula (I) according to the invention is, for example, obtained by an alkylation reaction of the cumylphenol in the presence of styrene, then by an alkoxylation reaction.

The experimental conditions of such an alkylation reaction of a cumylphenol in the presence of styrene are known to the person skilled in the art who may, for example, refer to document U.S. Pat. No. 2,432,356 which describes the alkylation of a phenol in the presence of styrene.

The compound of formula (I) may be mixed with other cyclic compounds, for example species of the cumylphenol type on which 2, 3, 4 and/or 6 styrenes are grafted.

These new polyurethanes make it possible, for example, to thicken a paint formulation at a low shear gradient, while limiting this increase at a higher gradient, in comparison to aromatic structures of the prior art, for example those described in patent application WO 02/102868.

Furthermore, the polyurethane comprises as a constituent b) a polyol that may be a poly(alkylene glycol).

“Poly(alkylene glycol)” refers to a polymer of an alkylene glycol derived from an olefinic oxide. The poly(alkylene glycol) chains of constitutent b) according to the present invention include a proportion of ethylene-oxy groups, a proportion of propylene-oxy groups and/or a proportion of butylene-oxy groups. The poly(alkylene glycol) chains according to the present invention may, for example, comprise a dominant proportion of ethylene-oxy groups in combination with a secondary proportion of propylene-oxy groups. Specific examples of alkylene glycol polymers include: poly(alkylene glycols) with an average molecular weight of 1,000, 4,000, 6,000 and 10,000 g/mol; polyethylene polypropylene glycols with a percentage of ethylene oxides comprised between 20 and 80% by weight and a percentage of propylene oxides comprised between 20 and 80% by weight.

According to one embodiment of the present invention, in the above formula (I):
m represents a non-zero whole number varying between 1 and 250 and
n and p represent, independent of one another, 0 or a whole number varying between 1 and 250 inclusive,
   the sum of m, n and p being comprised between 2 and 250, for example between 2 and 150 or for example between 3 and 100.

According to another embodiment of the present invention, in the above formula (I):
m and n represent a non-zero whole number varying between 1 and 250,
p is equal to 0,
   the sum of m and n being comprised between 2 and 250, for example between 2 and 150 or for example between 3 and 100.

According to yet another embodiment, in the above formula (I):
m represents a whole number varying between 2 and 250, for example between 2 and 150 or for example between 3 and 100 and
n and p are equal to 0.

According to this embodiment, said polyakyloxylated chain of the compound of formula (I) is exclusively consisted of ethoxylated units EO.

According to one aspect of the present invention, the polyurethanes result specifically from the condensation of a poly(alkylene glycol) which is poly(ethylene glycol). It may, for example, be a poly(ethylene glycol) whose molecular mass varies between 2,000 g/mol and 20,000 g/mol, for example between 8,000 g/mol and 15,000 g/mol inclusive. By way of example, the poly(ethylene glycol) (or PEG) with molecular mass varying between 10,000 g/mol and 12,000 g/mol inclusive may be cited.

“Polyisocyanate” refers to a compound that comprises at least 2 isocyanate —N═C═O functional groups.

According to one aspect of the present invention, the polyurethanes result specifically from the condensation of a polyisocyanate which is chosen from the group consisting of toluene diisocyanate, toluene diisocyanate dimers, toluene diisocyanate trimers, 1,4-butane diisocyanate, 1,6-hexane diisocyanate, isophorone diisocyanate, 1,3-cyclohexane diisocyanate, 1,4-cyclohexane diisocyanate, 4,4′ diisocyanatodicyclohexylmethane, 1-methyl-2,4-diisocyanatocyclohexane, diphenyl methylene diisocyanate (MDI), for example 2,2′-MDI, 2,4′-MDI, 4n4′-MDI or mixtures thereof, dibenzyl diisocyanate, a mixture of 1-methyl-2,4-diisocyanatocyclohexane and 1-methyl-2,6-diisocyanatocyclohexane, hexamethylene diisocyanate biuret, dimers of hexamethylene diisocyanate biuret, trimers of hexamethylene diisocyanate biuret and a mixture of at least two of these compounds.

According to one aspect of the invention, said polyurethane results from the condensation of:
a) 1% to 29% by weight of at least one compound of formula (I),
b) 70% to 98% by weight of at least one poly(alkylene glycol) and
c) 1% to 29% by weight of at least one polyisocyanate,
   the sum of these mass percentages being equal to 100%.

According to another aspect of the invention, said polyurethane results from the condensation of:
a) 3% to 10% by weight of at least one compound of formula (I),
b) 80% to 94% by weight of at least one poly(alkylene glycol) and
c) 3% to 10% by weight of at least one polyisocyanate,
   the sum of these mass percentages being equal to 100%.

The manufacturing of polyurethanes, which belong to the family of HEUR type thickeners, is known to the person skilled in the art, who may refer to the teaching of the documents cited above in the technological background of the present invention.

An object of the present invention also relates to a method for preparing a polyurethane as described above, said method consisting of a condensation of its different constituents.

### Aqueous Composition

The present invention also relates to an aqueous composition comprising a polyurethane according to the invention, as described above.

According to one embodiment, this polyurethane is coformulated in the presence of a coalescing agent, as described below, and a solvent.

According to another embodiment, said aqueous composition comprises a polyurethane according to the invention, as described above, as well as water and a surfactant.

Thus, according to this aspect of the invention, the polyurethane is formulated in water in the presence of at least one surfactant. This surfactant makes it possible to formulate the thickener in the form of a liquid aqueous solution that may thereby be more easily implemented by the formulator.

“Surfactant” refers to a molecule or polymer consisted of at least one hydrophilic part and at least one hydrophobic part.

The surfactant used in the context of the present invention may be of different nature, for example, it may be anionic or non-ionic.

This surfactant may be selected from the classes of ionic (in this case, preferably anionic) and/or non-ionic and/or mixed (including both non-ionic and anionic structures within the same molecule) surfactants. The preferred surfactant is composed of at least one surfactant selected from the class of non-ionic surfactants, eventually in the presence of an anionic surfactant.

Suitable anionic surfactants include salts of sodium, lithium, potassium, ammonium or magnesium derived from alkyl ether sulfates with alkyl varying from C6 to C12, in linear, iso, oxo, cyclic or aromatic configuration, or from C12 alkyl sulfates, from alkyl phosphate esters or dialkyl sulfosuccinates. Anionic surfactants are preferably used with at least one non-ionic surfactant.

Examples of mixed surfactants include alkoxylated alkyl phenol sulfonates. Non-ionic surfactants may be used alone or in combination with an anionic surfactant. Preferred examples of suitable non-ionic surfactants include: ethoxylated C12-C18 fatty alcohols (2 to 35 EO), iso-ethoxylated fatty alcohols (2 to 40 EO), ethoxylated monobranched C10-C18 fatty alcohols (2 to 40 EO), C18 sorbitol esters, ethoxylated sorbitol esters (5 to 20 EO units), or ethoxylated C12-C18 fatty acids (7 EO), ethoxylated ricin oil (30 to EU), ethoxylated hydrogenated ricin oil (7 to 60 EO), fatty esters such as: glycerol palmitate, glycerol stearate, glycol ethylene stearate, diethylene glycol stearate, propylene glycol stearate, polyethylene glycol 200 stearate or ethoxylated C18 fatty esters (2 to 15 EO).

The hydrophobic chains may correspond to linear, iso, oxo, cyclic or aromatic structures.

According to one embodiment, the composition comprises at least one non-ionic surfactant that may eventually be combined with at least one anionic surfactant, at a total content by weight of from 5% to 30% by weight, for example from 8% to 20% by weight or from 10% to 17% by weight. In this case, the ratio by weight between the two surfactants may, for example, vary between 25/75 and 75/25.

According to another embodiment of the present invention, said composition comprises more than two surfactants, for example three or four.

According to an aspect of the invention, the aqueous composition further comprises at least one additive selected from the group consisting of a biocide, a solvent, an anti-foaming agent, a pH regulator, a coalescent agent and mixtures thereof.

“Biocide” refers to a chemical substance intended to destroy, repel or render inoffensive harmful organisms, prevent them from acting or combat them in any other way, through chemical or biological action.

“Anti-foaming agent” refers to a substance or a formulation intended to eliminate air bubbles within a homogeneous or heterogeneous liquid medium (or on its surface) or to prevent those air bubbles from forming.

“pH regulator” or “pH regulating agent” refers to a chemical compound that makes it possible to adjust the pH to the expected value. For example, the pH regulating agent may increase the pH, as with bases, such as NaOH. Alternatively, the pH regulating agent may decrease the pH, as with acids.

“Coalescent agent” refers to an agent used in paints to lower the Minimum Film Formation Temperature (MFFT) of a paint to a temperature suitable for the desired conditions of application (for example, a MFFT of 5° C. for an outdoor application). Examples of coalescent agents according to the invention include propylene glycol, butyl glycol, 2,2,4-trimethyl-1,3-pentanediol monoisobutyrate or 2,2,4-trimethyl-1,3-pentanediol diisobutyrate, 2,2,4-trimethyl-1,3-pentanediol monoisobutyrate and derivatives of glycol ethers of the Dowanol® type.

According to one embodiment, said aqueous composition according to the invention consists of:
1) 5% to 50% by weight of at least one polyurethane according to the invention, as described above,
2) 5% to 30% by weight of at least one surfactant,
3) 20% to 75% by weight of water and
4) 0 to 5% by weight of at least one other additive chosen from the group consisting of a biocide, a solvent, an anti-foaming agent, a pH regulator, a coalescent agent and mixtures thereof,
   the sum of these mass percentages being equal to 100%.

### Aqueous Formulation

An object of the present invention consists of an aqueous formulation comprising a polyurethane according to the invention or an aqueous composition according to the invention, said formulation being selected from the group consisting of a paint, a putty, a render coating, a thick coating, a waterproof coating, a lacquer, a varnish, an ink, a mineral slurry, a paper coating colour, a cosmetic formulation and a detergent formulation.

The present invention also relates to the use of a polyurethane according to the invention or an aqueous composition according to the invention to thicken an aqueous formulation, said formulation being selected from the group consisting of a paint, a putty, a render coating, a thick coating, a waterproof coating, a lacquer, a varnish, an ink, a mineral slurry, a paper coating colour, a cosmetic formulation and a detergent formulation.

According to an aspect of the present invention, the aqueous formulation comprises from 0.02% to 5% by active ingredient weight of said thickener.

According to another aspect of the present invention, the aqueous formulation comprises from 0.05% to 2% by active ingredient weight of said thickener.

“Active ingredient weight” refers to the dry weight of polyurethane according to the invention, regardless of the coformulation ingredients.

According to still another aspect of the present invention, the aqueous formulation comprises at least one mineral filler selected from the group consisting of calcium carbonate, kaolin, talc and silicate, and/or at least one pigment selected from the group consisting of titanium dioxide, iron oxide and zinc.

According to an aspect of the present invention, the aqueous formulation is a paint and comprises at least one dispersing agent, at least one filler or mineral pigment, at least one binder, at least one biocide, at least one anti-foaming agent and eventually a surfactant, a surface agent and/or a coalescent agent.

The following examples allow a better understanding of the present invention, without limiting its scope.

### EXAMPLES

The viscosity of the test formulations or paint formulations are determined at different velocity gradients:
at a low velocity gradient, the Brookfield viscosity, which is measured using an RVT type Brookfield viscometer, in the non-agitated flask, at a temperature of 25° C. and at two rotational velocities of 10 and 100 revolutions per minute with the appropriate spindle. Reading is taken after 1 minute of rotation. The result is two Brookfield viscosity measurements, respectively noted μ_{Bk10} and μ_{Bk100} (mPa·s),
at medium velocity gradient: Stormer viscosity, noted μ_{S} (Krebs Units) and
at high velocity gradient: Cone Plan viscosity or ICI viscosity, noted μ_{I} (mPa·s).

### Example 1

This example illustrates the thickening power of polyurethanes in simple formulations containing a binder, water and said polyurethanes, making it possible to obtain a good level of discrimination between each test.

It illustrates the thickening power of a polyurethane according to the invention (tests 1-2 and 1-4), using a compound of formula (I) comprising 3 ethylene oxide units.

At the same time, this example also illustrates a polyurethane (tests 1-1 and 1-3) according to patent application WO 02/102868, using a tristyrylphenol compound comprising 3 units of ethylene oxide.

Both of the described polyurethanes result from the condensation of, expressed as a percentage by weight in relation to the total weight of the polyurethane:
86% by weight of poly(ethylene glycol) with a molecular mass by weight equal to 10,000 g/mol,
9% by weight of said hydrophobic compound and
5% by weight of isophorone diisocyanate.

All of these polyurethanes are formulated in water in the presence of a surfactant which is a C8-C10 fraction of an alkoxylated fatty alcohol (Simulsol® OX1008). The PU/surfactant/water mass ratios are indicated in table 1 below.

### Thickening Power Test

In each of the tests No. 1-1 to 1-4, 140 g of Mowilith™ LDM 1871, 120 g of bipermutated water and 32.8 g of the composition to be tested are introduced into a beaker.

At 25° C., the Brookfield™ viscosities at 10 and 100 revolutions per minute (μ_{Bk10} et μ_{Bk100}, in mPa·s), the Stormer™ viscosity (μ_{S}, in Krebs Units KU) measured with the standard module and the ICI viscosity (μ_{I}, en mPa·s) of the formulation are then measured.

The results appear in table 1.

TABLE 1

| Test No. | 1-1 | 1-2 | 1-3 | 1-4 |
|---|---|---|---|---|
| Thickener in the form of an | 17.5/ | 17.5/ | 17.5/ | 17.5/ |
| aqueous composition: | 11.5/71 | 11.5/71 | 15/67.5 | 15/67.5 |
| PU/surfactant/water ratio | | | | |

| | |
|---|---|
| Test formulation | |
| water | Water: 120 g |
| binder: Mowilith ™ LDM 1871 | Binder: 140 g |
| thickener | Thickener: 32.8 g |

| Prior Art INVention | PA | INV | PA | INV |
|---|---|---|---|---|
| μ_{Bk10} | 1,600 | 2,720 | 780 | 2,420 |
| μ_{Bk100} | 1,550 | 2,152 | 780 | 1,970 |
| μ_{S} | 92 | 103 | 73 | 99 |
| μ_{I} | 200 | 170 | 160 | 160 |

The tests according to the invention develop a greatly improved thickening at a low velocity gradient, which translates into a high increase in Brookfield viscosities measured at 10 revolutions per minute and even greater at 100 revolutions per minute compared to the tests of the prior art.

### Example 2

This example illustrates the thickening power of polyurethanes in simple formulations containing a binder, water and said polyurethanes.

It illustrates the thickening power of:
test 2-2: polyurethane according to the invention, using a compound of formula (I) comprising 3 ethylene oxide units,
test 2-4: polyurethane according to the invention, using a compound of formula (I) comprising 15 ethylene oxide units and
test 2-6: polyurethane according to the invention, using a compound of formula (I) comprising 25 ethylene oxide units.

At the same time, this example also illustrates the thickening power of:
test 2-1: a polyurethane according to patent application WO 02/102868, using a tristyrylphenol compound comprising 3 ethylene oxide units,
test 2-3: a polyurethane according to patent application WO 02/102868, using a tristyrylphenol compound comprising 15 ethylene oxide units and
test 2-5: a polyurethane according to patent application WO 02/102868, using a tristyrylphenol compound comprising 25 ethylene oxide units.

The described polyurethanes result from the condensation of, expressed as a percentage by weight in relation to the total weight of the polyurethane:
86% by weight of poly(ethylene glycol) with molecular mass by weight equal to 10,000 g/mol,
9% by weight of said hydrophobic compound and
5% by weight of isophorone diisocyanate.

All of these polyurethanes are formulated in water in the presence of a surfactant which is a C8-C10 fraction of an alkoxylated fatty alcohol (Simulsol® OX1008). The PU/surfactant/water mass ratios are indicated in table 2 below.

### Thickening Power Test

In each of the tests 2-1 to 2-6, 150.0 g of Axilat™ DS 910, 140.0 g of bipermutated water, 0.4 g of 30% ammonia and 10.0 g of the composition to be tested are introduced into a beaker.

At 25° C., the Brookfield™ viscosities at 10 and 100 revolutions per minute (μ_{Bk10} et μ_{Bk100}, en mPa·s), the Stormer™ viscosity (μ_{S}, in Krebs Units KU) (measured with the “paste spindle” module) and the ICI viscosity (μ_{I}, en mPa·s) of the formulation are then measured.

The results appear in table 2.

TABLE 2

| Test No. | | | | | | |
|---|---|---|---|---|---|---|
| Thickener in the form of | 17.5/15/ | 17.5/15/ | 17.5/15/ | 17.5/15/ | 17.5/15/ | 17.5/15/ |
| an aqueous composition: | 67.5 | 67.5 | 72.5 | 67.5 | 67.5 | 67.5 |
| PU/surfactant/water ratio | | | | | | |
| Test formulation | | | | | | |

| | |
|---|---|
| water | Water: 140 g |
| binder: AXILAT | Binder: 150 g |
| DS 910 | |
| thickener | Thickener: 10 g |

| | Prior Art INVention | | | | | |
|---|---|---|---|---|---|---|
| | PA | INV | PA | INV | PA | INV |
| μ_{Bk10} | 14,100 | 47,800 | 2,100 | 5,000 | 300 | 800 |
| μ_{Bk100} | 6,550 | 8,110 | 1,810 | 2,520 | 260 | 680 |
| μ_{S} | 114 | 120 | 96 | 94 | 61 | 74 |
| μ_{I} | 400 | 300 | 500 | 200 | 200 | 100 |

The tests according to the invention develop a greatly improved thickening at a low velocity gradient, which translates into a high increase in Brookfield viscosities measured at 10 revolutions per minute and even greater at 100 revolutions per minute compared to the tests of the prior art.

### Example 3

This example illustrates the use of a thickener according to the invention in a solvent-free, high-PVC, aqueous, matt paint formulation (comprising an ethylene vinyl acetate (EVA) binder type)), whose composition is given in table 3 below.

It illustrates the thickening power of a polyurethane according to the invention (test 3-2), using a compound of formula (I) comprising 3 ethylene oxide units.

At the same time, this example also illustrates a polyurethane (test 3-1) according to patent application WO 02/102868, using a tristyrylphenol compound comprising 3 ethylene oxide units.

Both of the described polyurethanes result from the condensation of, expressed as a percentage by weight in relation to the total weight of the polyurethane:
86% by weight of poly(ethylene glycol) with molecular mass by weight equal to 10,000 g/mol,
9% by weight of said hydrophobic compound and
5% by weight of isophorone diisocyanate.

The two polyurethanes are formulated in water in the presence of a surfactant which is a C8-C10 fraction of an alkoxylated fatty alcohol (Simulsol®OX1008). The PU/surfactant/water ratios are 17.5/11.5/71.

All of the results have been complied in table 3.

For each of the tests, the viscosities μ_{BK10}, μ_{BK100}, μ_{I} (in mPa·s) and μ_{S} (in Krebs Units KU measured with the standard module) have been determined according to the methods described above at T=0 and T=24 hours at room temperature.

TABLE 3

| | Test 3-1 | Test 3-2 |
|---|---|---|
| | PA | INV |
| Constituent of paint Mass (g) | | |
| Water | 323 | 323 |
| Dispersant (Ecodis ® P50) | 4 | 4 |
| Biocide (Acticide ® MBS) | 2 | 2 |
| Anti-foaming agent (Byk ® 34) | 1 | 1 |
| TiO₂ (TiONA 568) | 40 | 40 |
| CaCO₃ (Omyacoat ® 850OG) | 210 | 210 |
| CaCO₃ (Durcal ® 5) | 330 | 330 |
| Binder (Mowilith ® LDM 1871) | 80 | 80 |
| Ammonia 30% (qsp pH = 9) | 0.1 | 0.1 |
| Thickener | 40 | 40 |

Results

| | | | |
|---|---|---|---|
| T = 0 | μ_{Bk10} | 7,900 | 10,100 |
| | μ_{Bk100} | 2,050 | 3,100 |
| | μ_{S} | 97 | 106 |
| | μ_{I} | 1.7 | 1.3 |
| T = 24 h | μ_{Bk10} | 8,800 | 10,300 |
| | μ_{Bk100} | 2,390 | 3,130 |
| | μ_{S} | 100 | 107 |
| | μ_{I} | 170 | 130 |

The tests according to the invention develop a greatly improved thickening at a low velocity gradient in a paint formulation, which translates into a high increase in Brookfield viscosities measured at 10 revolutions per minute and at 100 revolutions per minute compared to the tests of the prior art.

1: A water-soluble polyurethane resulting from the condensation of:
a) at least one compound of formula (I): 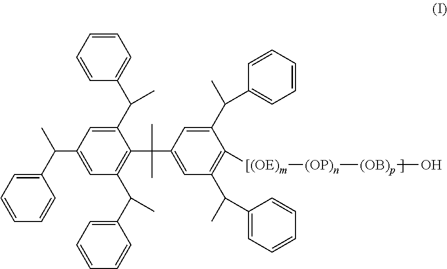
wherein:
[(EO)ₘ—(PO)ₙ—(BO)ₚ] represents a polyalkoxylated chain constituted of alkoxylated units, in block, alternated or random structures, chosen from among ethoxylated units EO, propoxylated units PO and butoxylated units BO and
m, n and p represent, independent of one another, 0 or a whole number varying between 1 and 250 inclusive, the sum of m, n and p being between 2 and 250,
b) at least one polyol, for example at least one poly(alkylene glycol) and
c) at least one polyisocyanate.

2: The polyurethane according to claim 1, resulting from the condensation of:
a) 1% to 29% by weight of at least one compound of formula (I),
b) 70% to 98% by weight of at least one poly(alkylene glycol) and
c) 1% to 29% by weight of at least one polyisocyanate,
the sum of these mass percentages being equal to 100%.

3: The polyurethane according to claim 1, resulting from the condensation of:
a) 3% to 10% by weight of at least one compound of formula (I),
b) 80% to 94% by weight of at least one poly(alkylene glycol) and
c) 3% to 10% by weight of at least one polyisocyanate,
the sum of these mass percentages being equal to 100%.

4: The polyurethane according to claim 1, according to which the poly(alkylene glycol) is a poly(ethylene glycol) having a molecular mass between 2,000 g/mol and 20,000 g/mol.

5: An aqueous composition comprising a polyurethane according to claim 1.

6: The aqueous composition according to claim 5, further comprising water and a surfactant.

7: The aqueous composition according to claim 5, further comprising at least one additive selected from the group consisting of a biocide, a solvent, an anti-foaming agent, a pH regulator, a coalescent agent and mixtures thereof.

8: The aqueous composition according to claim 5, consisting of:
1) 5% to 50% by weight of the at least one polyurethane,
2) 5% to 30% by weight of at least one surfactant,
3) 20% to 75% by weight of water and
4) 0 to 5% by weight of at least one other additive chosen from the group consisting of a biocide, a solvent, an anti-foaming agent, a pH regulator, a coalescent agent and mixtures thereof,
the sum of these mass percentages being equal to 100%.

9: An aqueous formulation comprising a polyurethane according to claim 1, said formulation being selected from the group consisting of a paint, a putty, a render coating, a thick coating, a waterproof coating, a lacquer, a varnish, an ink, a mineral slurry, a paper coating colour, a cosmetic formulation and a detergent formulation.

10: A process, comprising thickening an aqueous formulation with a polyurethane according to claim 1, said formulation being selected from the group consisting of a paint, a putty, a render coating, a thick coating, a waterproof coating, a lacquer, a varnish, an ink, a mineral slurry, a paper coating colour, a cosmetic formulation and a detergent formulation.
